(19) United States
(12) Patent Application Publication
(10) Pub. No.: US 2007/0010211 A1
(43) Pub. Date: Jan. 11, 2007

(54) CELL PHONE AND CORDLESS PHONE WITH INVERTED KEYPAD AND DISPLAY ARRANGEMENT AND SLANTED ROWS OF BUTTONS ON KEYPAD

(76) Inventor: Jerry Mixon, Seattle, WA (US)

Correspondence Address: PAI PATENT & TRADEMARK LAW FIRM, 1001 FOURTH AVENUE, SUITE 3200, SEATTLE, WA, 98154, US

(21) Appl. No.: 11/428,566

(22) Filed: Jul. 4, 2006

Related U.S. Application Data
(60) Provisional application No. 60/595,453, filed on Jul. 7, 2005.

(51) Int. Cl. H04B 1/38

(52) U.S. Cl. 455/90.3

(57) ABSTRACT

Hand-held telephones (i.e., cell phones or cordless phones) with its keypad and display in inverted (from customary layout) positions and with a slanted keypad arrangement are disclosed in this application. Such a revision of the face layout of this type of telephone allows the user to dial or access the keypad with the thumb of the hand holding the phone with relative ease and with better ergonomics compared to the conventional phone face layout.

### CROSS-REFERENCE TO RELATED APPLICATIONS

This application claims the benefit of U.S. Provisional Application No. 60/595,453, which was filed Jul. 7, 2005 and is now pending.

### BACKGROUND OF THE INVENTION

1. Field of the Invention

The present invention relates generally to hand-held phones with a nontraditional face layout and, more particularly, to a cell phone or cordless phone with keypad and LCD display inverted from the customary layout and with keys on the keypad arranged in a slanted pattern instead of the customary arrangement of vertical and horizontal lines.

2. Description of the Related Art

The conventional arrangement of the face of hand-held phones, such as cell and cordless phones, has the LCD display located at the upper part and the keypad of buttons located on the lower part. Although hand-held phone units were originally conceived to be held with one hand and dialed with fingers of the other hand, but in actual practice it has become common for many people to dial the phone with the thumb of the same hand holding the unit. In order to accomplish thumb dialing with the conventional phone face layout (i.e., keypad below and display above), it is necessary to reach awkwardly down with the thumb, and at the same time move the unit to the fingers. The result is a poor grip on the phone unit, and, more importantly, bad ergonomics that contributes to fatigue and pain in the hand and arm because of the strain, especially after long and continuous use, as is often the case with instant messaging with the phone.

The objective of the present invention is to provide a phone face arrangement that makes the phone unit easier to hold, easier to dial or press the buttons, and is less straining for the thumb of the hand holding the phone while navigating around the keypad to press the keys.

### SUMMARY OF THE INVENTION

This invention discloses a cell phone or cordless phone with a significant alteration of the standard face layout by inverting the arrangement of the keypad and the display, and by slanting the rows of buttons or keys on the keypad. Such an arrangement makes the cell phone or cordless phone easier to use and less straining for the thumb when dialing or otherwise accessing the keypad with the thumb of the same hand holding the phone. With the keypad located above the display, the user's thumb will tend to be in a more natural and relaxed position while dialing, and a slanted arrangement of the keys that follows the sweep of the thumb makes dialing easier, rather than following a rigid vertical and horizontal line arrangement as with the conventional phone layout.

Presently, no hand-held type of cell phone or cordless phone offers purchasers a choice of location of keypad and display as described in this application. Since the conventional lower location of the keypad leads to an awkward reach with the thumb, some people turn the telephone upside down to dial. But they then have to read the display and key numbers upside down; moreover, after the call is connected, they have to return the cell phone to the original position in order to speak to the microphone and hear through the earpiece. Therefore, given a choice, it is very likely that many people would prefer to use a cell phone or cordless phone with the locations of the keypad and LCD display reversed in order to reduce the risk of tendon fatigue and long-term damage.

### BRIEF DESCRIPTION OF THE DRAWINGS

FIG. 1 illustrates a cell phone according to the first embodiment of the present invention, wherein the keypad is at the top and the display is at the bottom.

FIG. 2 illustrates a cell phone in the hand to demonstrate the security of grip on the phone while dialing, and the position of the thumb on the arc of the keys.

FIG. 3 illustrates a hinged cell phone according to the second embodiment of the present invention to demonstrate the location of keypad above, and LCD below.

FIG. 4 illustrates a hinged cell phone in the hand to demonstrate the grip on the phone while dialing, and the position of the thumb on the arc of the keys.

FIG. 5 illustrates the third embodiment of the present invention, wherein the keypad and LCD arrangement of a cordless phone handset are inverted.

### DETAILED DESCRIPTION OF THE INVENTION

The standard keypad and LCD display layout of conventional cell phones and cordless phones for land-based telephone have the keypad at the bottom and the LCD display at the top; the buttons or keys on the keypad are arranged in horizontal rows and vertical columns. The main inventive thrusts of the present application are to invert the arrangement and place the keypad at the top and the LCD display at the bottom, and to slant the rows of buttons or keys to better accommodate the sweep of the thumb for dialing with the thumb of the hand holding the unit. As a result, the earpiece remains at the top of the unit (but now above the keypad), and the microphone remains at the bottom of the unit (but now below the LCD display).

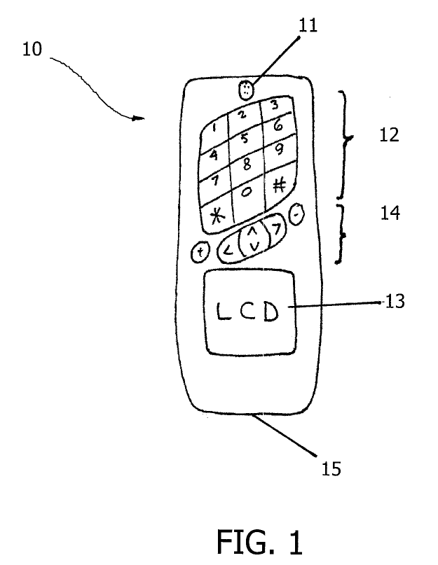

FIG. 1 is a schematic of a cell phone 10 according to a first embodiment of the present invention, which comprises an earpiece 11 at a top end of the phone 10, a keypad 12 below the earpiece 11, a microphone 15 at a bottom end of the phone 10, and a display 13 above the microphone 15 and below the keypad 12. Furthermore, a plurality of function keys or soft keys 14 are disposed between the keypad 12 and the display 13. In FIG. 1, the keypad 12 is above the display 13. In contrast, a conventional cell phone (not shown) with a keypad and display has the display above the keypad. Like a standard phone keypad, the keypad 12 shown in FIG. 1 consists of 12 keys in four rows for entering numbers 1-9, asterisk sign (*), number 0, and pound sign (#). However, the keypad 12 is different from a standard phone keypad in that the rows of keys are slanted upward from left to right.

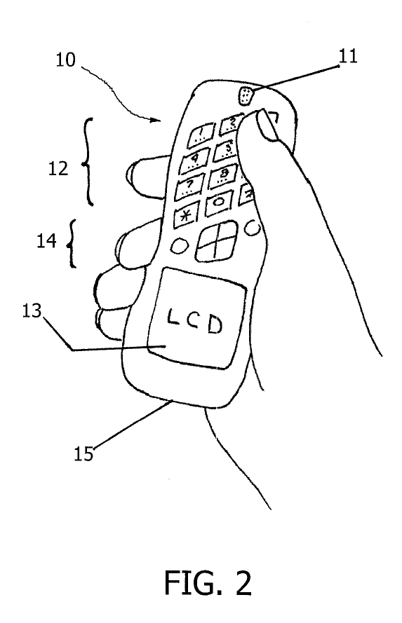

FIG. 2 illustrates a cell phone 10 in the hand to demonstrate the inverted arrangement of the face layout and the more natural lay of the thumb over the keys, and the better grip that results from not having to cradle the unit on the fingers (as is necessary when reaching down with the thumb on conventional units). It can be seen from FIG. 2 that the slanted rows of keys of the keypad 12 further eases the task of dialing by the thumb of a right hand. Similarly, if a user is left-handed (namely, using the left thumb to dial the phone), then a keypad 12 with the rows of keys slanted downward from left to right would be desirable.

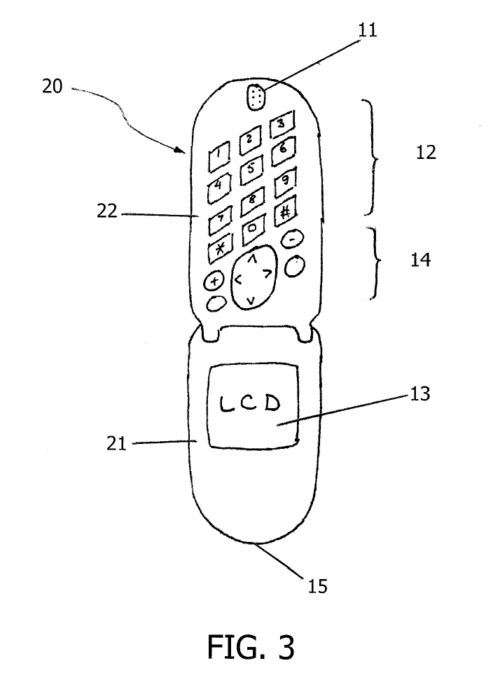

FIG. 3 is a schematic of a hinged cell phone 20 according to the second embodiment of the present invention. The hinged cell phone 20 comprises a base portion 21 and a flap portion 22 hinged at one end to the base portion 21, wherein a display 13 and a microphone 15 are disposed at the base portion 21 whereas the keypad 12 is located at the flap portion 22 below the earpiece 11. Therefore, when the flap portion 22 of the phone 20 is opened (or raised) for dialing, the keypad 12 is located at the top and the display 13 is at the bottom. In contrast, a conventional hinged cell phone (not shown) has the display at the top and the keypad at the bottom.

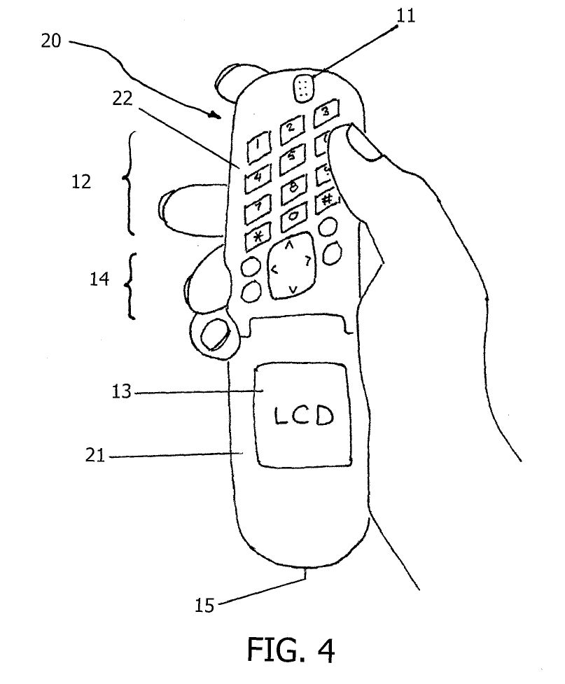

FIG. 4 illustrates a hinged cell phone 20 in the hand to demonstrate the inverted arrangement of face layout and the more natural lay of the thumb on the keys and the better grip that results from not having to cradle the unit on the fingers (as is necessary when reaching down with the thumb on conventional units). FIG. 4 also illustrates the relative ease for dialing by the thumb of a right hand with the rows of keys slanted upward from left to right. Similarly, a hinged cell phone with the rows of keys slanted downward from left to right can be provided for left-handed users.

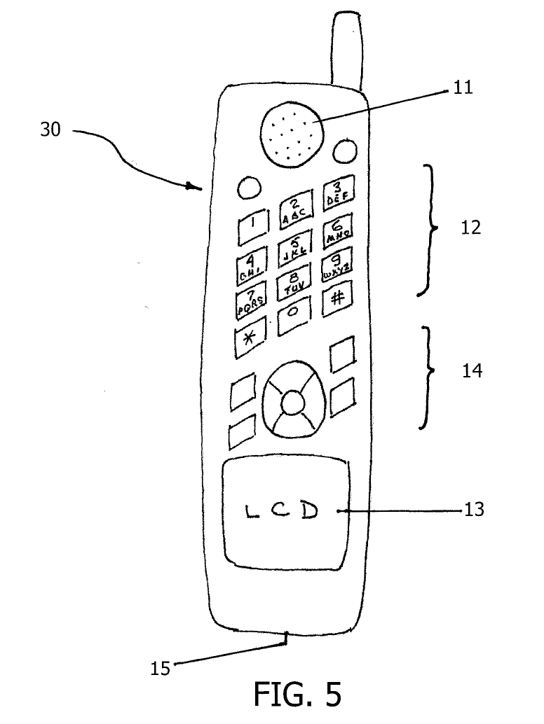

FIG. 5 is a schematic of a cordless phone 30 according to the third embodiment of the present invention, wherein the keypad 12 is located at the top and the display 13 is at the bottom. In contrast, the typical conventional cordless phone (not shown) has the keypad at the bottom and the display at the top.

In summary, placing the keypad 12 at the top of the unit and the display 13 at the bottom makes it easier for the thumb to navigate around the keypad 12 and press the keys. Additionally, the typical hand-held phone is often designed to have the widest part of the phone in the area of the LCD display, and putting the LCD display at the bottom of the unit instead of at the top puts the widest part of the unit in the palm. Consequently, a better grip can be maintained on the phone while dialing.

None of the figures above are intended to dictate the location or order of numbers, letters, nor symbols on the keys or buttons. But the arrangement of buttons or keys in slanted rows to accommodate the sweep of the thumb (of the hand that is holding the unit) is relevant to the invention. Designations of numbers, letters, and symbols on keys or buttons are at the discretion of phone manufacturers or customs in the industry.

In all of the figures above, the rows of keys or buttons on the keypad 12 are shown slanted upward from left to right for the benefit of right-handed users. The phones may be easily modified to have the rows of keys or buttons slanted downward from left to right for left-handed users. In both cases, the rows are slanted preferably at an angle between 30° to 40°. To further minimize the strain on the thumb, the keypad 12 may be designed to have the keys or buttons off-centered, i.e. shifted more toward the left side of the face of the phone for right-handed users or shifted more toward the right side of the face of the phone for left-handed users.

Alternatively, the keys of the keypad 12 can also be arranged in slanted arcs of keys instead of straight rows. Such layout of keys lets the keys fall more naturally under the sweep of the thumb while holding the unit with the same hand. The result is a less awkward reach for the thumb, and, therefore, less likelihood of fatigue and long-term tendon damage.

As shown in FIGS. 1 and 3, it's very common for hand-held phones to have a plurality of “functions keys”, or “soft keys” 14 for menu scrolling and selection, power on/off, starting or ending a call, etc. Preferably, these function keys 14 are disposed between the keypad 12 and the display 13, i.e., below the keypad 12 and above the display 13. Preferably, the function keys 14 for a hinged cell phone are disposed at the flap portion 22 below the keypad 12, also in slanted arrangement. Thus, the function keys 14 of the hand-held phone according to the present invention are located at a location relatively higher than those in the conventional hand-held phone. As a result, they can be accessed and pressed by the thumb with less straining and bending.

The locations of volume keys, headset jack, antenna, charging ports, and other internal and external vital elements of telephones will be at the discretion of the phone manufacturers, and may presumably be optimized for the novel arrangement. The present invention does not dictate nor restrict their necessary locations in any way.

Although this invention may not appeal to all users of hand-held telephone units, it will give consumers who prefer to dial with the thumb of the hand holding the phone a choice in the layout of keypad and LCD on the face of the device.

The present invention has been described with a few of its preferred embodiments as illustrative examples. The embodiments described are not intended to limit the scope of the claims, which certainly should cover all other equivalents and variations as legally permitted.

I claim:

1. A hand-held phone with inverted keypad and display arrangement, comprising
an earpiece;
a display;
a keypad comprising twelve keys for entering numbers 1 to 9, asterisk sign (*), number 0, and pound sign (#); and
a microphone,
wherein the earpiece is located at a top end of the phone, the microphone is located at a bottom end of the phone, the keypad is located below the earpiece, and the display is located below the keypad and above the microphone.

2. The hand-held phone as in claim 1, wherein the twelve keys of the keypad are arranged in four rows of three keys each: the first row for entering numbers 1 to 3, the second row for numbers 4 to 6, the third rows for numbers 7 to 9, and the fourth row for entering asterisk sign, number 0 and pound sign, respectively.

3. The hand-held phone as in claim 2, wherein the four rows of keys of the keypad are each a straight row slanted upward from left to right.

4. The hand-held phone as in claim 3, wherein the four rows of keys of the keypad are each slanted at an angle between 30° to 40°.

5. The hand-held phone as in claim 2, wherein the four rows of keys of the keypad are each a straight row slanted downward from left to right.

6. The hand-held phone as in claim 5, wherein the four rows of keys of the keypad are each slanted at an angle between 30° to 40°.

7. The hand-held phone as in claim 2, wherein the keypad is placed off-centered toward the left or toward the right.

8. The hand-held phone as in claim 1, wherein the hand-held phone is a cell phone.

9. The hand-held phone as in claim 1, wherein the hand-held phone is a cordless phone for land-based telephone.

10. The hand-held phone as in claim 1, further comprising a plurality of phone function keys disposed between the keypad and the display.

11. A hinged cell phone with inverted keypad and display arrangement, comprising
a base portion having a display and a microphone; and
a flap portion having a first end hinged to the base portion, an earpiece disposed at a second end thereof, and a keypad comprising twelve keys for entering numbers 1 to 9, asterisk sign (*), number 0, and pound sign (#).

12. The hinged cell phone as in claim 11, wherein the twelve keys of the keypad are arranged in four rows of three keys each: the first row for entering numbers 1 to 3, the second row for numbers 4 to 6, the third row for numbers 7 to 9, and the fourth row for entering asterisk sign, number 0 and pound sign, respectively.

13. The hinged cell phone as in claim 12, wherein the four rows of keys of the keypad are each a straight row slanted upward from left to right.

14. The hinged cell phone as in claim 13, wherein the four rows of keys of the keypad are each slanted at an angle between 30° to 40°.

15. The hinged cell phone as in claim 12, wherein the four rows of keys of the keypad are each a straight row slanted downward from left to right.

16. The hinged cell phone as in claim 15, wherein the four rows of keys of the keypad are each slanted at an angle between 30° to 40°.

17. The hinged cell phone as in claim 11, wherein the keypad is placed off-centered toward the left or toward the right.

18. The hinged cell phone as in claim 11, further comprising a plurality of phone function keys disposed in the flip portion between the keypad and the first end of the flip portion.
